(19) United States
(12) Patent Application Publication
(10) Pub. No.: US 2023/0055263 A1
(43) Pub. Date: Feb. 23, 2023

(54) STRATIFICATION IN NON-CLASSIFIED HETEROGENEOUS OBJECT LABELS

(71) Applicant: Dynam.AI, INC., San Diego, CA (US)

(72) Inventors: Yang ZHONG, San Diego, CA (US); Dimitry FISHER, San Diego, CA (US)

(21) Appl. No.: 17/893,005

(22) Filed: Aug. 22, 2022

Related U.S. Application Data
(60) Provisional application No. 63/259,946, filed on Aug. 21, 2021.

(51) Int. Cl. G06N 20/00

(52) U.S. Cl. CPC G06N 20/00

(57) ABSTRACT

Certain aspects of the present disclosure provide techniques for stratifying data samples for use in machine learning and/or data analytics. A method generally includes extracting one or more meta attributes from each respective data sample of a plurality of data samples in a dataset; generating a plurality of hyper information frames, wherein each respective hyper information frame is associated with a respective data sample of the plurality of data samples and comprises the data sample and at least a subset of the one or more meta attributes extracted from the respective data sample; converting any non-numeric attribute value in each hyper information frame of the plurality of hyper information frames into a numeric attribute value; generating reduced dimensionality hyper information frames; clustering the reduced dimensionality hyper information frames into a plurality of clusters; and stratifying the data samples by sampling from the plurality of clusters.

### CROSS-REFERENCE TO RELATED APPLICATIONS

This Application claims the benefit of and priority to U.S. Provisional Patent Application Ser. No. 63/259,946, entitled “Sinchol: stratification in non-classified heterogeneous object labels,” filed Aug. 21, 2021, the contents of which are hereby incorporated by reference in their entirety.

### INTRODUCTION

Aspects of the present disclosure relate to data stratification, and more specifically, stratification of data samples for use in machine learning and/or data science.

### BACKGROUND

In recent years, machine learning based algorithms have demonstrated great success with respect to computer vision and natural language processing (NLP) tasks in both academia and industry. Computer vision and NLP are different fields of artificial intelligence (AI). While computer vision refers to the ability of a computer program to derive information from images, video, and/or other data inputs, NLP refers to the ability of a computer program to understand human language as it is spoken and written, referred to as natural language. Compared to conventional approaches, machine learning models have proven their ability to learn useful features that facilitate target tasks (e.g., such as computer vision and NLP tasks) and deliver results, in some cases, outperforming humans.

A scientific methodology has been long established for machine learning techniques to leverage data for model training. In particular, machine learning based algorithms function by making data-driven predictions and/or decisions, through building a mathematical model from an input dataset. The input dataset used to build the model may be divided into multiple datasets (also referred to as “splits”). For example, three datasets, including (1) a training dataset, (2) a validation dataset, and (3) a test dataset (also referred to as a “hold-out dataset”), are commonly used in different stages of the training of the model. Splitting the input dataset into training, validation, and test datasets helps to more accurately evaluate performance of the model, as well as to prevent the model from being overfitted. Overfitting is a concept that occurs when a statistical model fits exactly against its training data, but performs poorly against data on which it has not been trained.

As an illustrative example, when training a computer vision model, inputs such as images and/or videos may be shown to the model to train the model to predict or return concepts or labels. The model may use a loss function to inform the model how close, or far away, the model is from making a correct prediction. The model may learn a prediction function based on the loss function, mapping pixels in an image or video to an output. The risk in such a training process is that the model may overfit to the particular dataset (e.g., input image or video and their corresponding label(s)) used to train the model. That is, the model may learn an overly specific function that performs well on the training dataset, but does not generalize to input (e.g., images and/or videos) the model has not previously seen. Stratifying training data into training, validation, and test datasets may be used to combat such overfitting.

The training dataset refers to a first partition of an input dataset that is used to train a machine learning model according to a given learning algorithm Generally, a training dataset includes both model input data and the expected output(s) based on the input data, sometimes referred to as labels. The training dataset may generally make up a majority of the input dataset (e.g., around 60-70%).

The validation dataset refers to a second partition of the input dataset that is used to provide an unbiased evaluation of the model fit on the training dataset while training the model. As such, the model may occasionally “see” the validation data, but not “learn” from the validation data.

Lastly, the test (hold-out) dataset refers to a third partition of the input dataset that is used to provide an unbiased evaluation of a final version of the model after training. In other words, the test dataset may generally be used after a model has been completely trained in order to estimate the real-world performance of the model after training is completed. This well-accepted procedure is sometimes referred to as the “benchmark evaluation” approach.

Stratification of datasets used for training and evaluating machine learning models is crucial to ensure that each dataset (or data subset) (e.g., training, validation, and test) provides an adequate and “fair” representation of the data samples in the dataset. A “fair” representation refers to a partition of data samples in the dataset grouped into one or more datasets, where each of the one or more datasets includes equal representations of certain statistical and/or semantic attributes (e.g., similarly characterized data) in the available attributes (e.g., without bias). However, conventional procedures for dividing a dataset into different dataset subsets for different learning phases (e.g., as described above) often result in sampling bias (e.g., sampling bias may arise where certain data in the dataset is systematically under-represented or over-represented in one or more of the training, validation, or test datasets) Consequently, improved techniques for splitting a dataset to generate one or more fair dataset subsets are desired.

Accordingly, improved techniques for data stratification, which may help to ensure adequate and fair representations of data samples of a dataset for use in machine learning, and which in-turn improve the training and performance of machine learning models, are described herein.

### SUMMARY

Certain embodiments provide a method stratifying data samples for use in machine learning. The method generally includes extracting one or more meta attributes from each respective data sample of a plurality of data samples in a dataset; generating a plurality of hyper information frames, wherein each respective hyper information frame of the plurality of hyper information frames is associated with a respective data sample of the plurality of data samples and comprises the data sample and at least a subset of the one or more meta attributes extracted from the respective data sample; converting any non-numeric attribute value in each hyper information frame of the plurality of hyper information frames into a numeric attribute value; generating reduced dimensionality hyper information frames; clustering the reduced dimensionality hyper information frames into a plurality of clusters; and stratifying the data samples by sampling from the plurality of clusters.

Other embodiments provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### DESCRIPTION OF THE DRAWINGS

The appended figures depict certain aspects of the one or more embodiments and are therefore not to be considered limiting of the scope of this disclosure.

FIG. 1 illustrates an example system in which a plurality of data samples in a dataset are stratified for use in machine learning, according to aspects of the present disclosure.

FIG. 2 illustrates an example connectivity between a dataset and components of the hyper information preprocessing component illustrated in FIG. 1, according to aspects of the present disclosure.

FIG. 3 illustrates example operations that may be performed by a computing system to stratify a plurality of data samples, according to aspects of the present disclosure.

FIG. 4 illustrates an example system on which aspects of the present disclosure can be performed.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for stratifying data samples in a dataset for use in machine learning. The data samples may be stratified into one or more datasets (or data subsets), including for example, (1) a training dataset, (2) a validation dataset, and/or (3) a test dataset.

As mentioned briefly above, conventional methods for stratifying datasets for use with machine learning often results in biased data subsets, which negatively affect the validity of the training procedure and results, and ultimately compromise the performance of the trained machine learning model in real world tasks.

One conventional way of splitting a dataset is according to labels, which may be referred to as a “free split” because the information for making the split is part and parcel with a data sample. For example, where data samples are labeled into binary classes, it is possible to split the data into training, validation, and test datasets having approximately equal numbers of each class. However, when the predefined “free” splits are not available, dataset splits may be generated via random sampling or simple stratified sampling based on, for example, annotations with a simple structure (e.g., multi-class classification). For example, random sampling may involve randomly selecting data (e.g., inputs and their corresponding label(s)) from the dataset to create one or more datasets for model training and/or evaluation without any other consideration. Stratified random sampling, on the other hand, may involve first dividing the dataset into smaller groups, or strata, based on shared characteristics and then randomly selecting data from each of the smaller groups to create one or more datasets for model training and/or evaluation. Unfortunately, such random sampling techniques seldom, if ever, guarantee statistical similarity among created datasets.

Further, stratified random sampling of datasets that include data samples without labels, or with multiple labels, may be challenging. For example, in single-label classification, data samples of the dataset may belong to one label (e.g., a first image may belong to only a “cat” label while a second image may belong to only a “fish” label). Accordingly, stratified random sampling may be used to (1) divide the data samples into strata, based on their corresponding label (e.g., where each group is defined by a mutually exclusive label) and (2) randomly take samples from each of the groups, or strata, to create one or more datasets for model training and/or evaluation. However, in multi-label classification, data samples of a dataset may belong to more than one label and may be annotated as such (e.g., a first image may belong to a “cat” and a “fish” label where both a cat and a fish are present in the first image). Accordingly, due to co-occurrence of labels for one or more data samples, it may be difficult to stratify data samples of a dataset based on semantic labels (e.g., object categories). This problem exists on many popular datasets used for training machine learning models. As such, using random splitting to generate training, validation, and/or test datasets from a dataset often results in biased data that compromises training and ultimate model performance.

Given stratification based on semantic categories is often not feasible, as described above, aspects of the present disclosure propose stratifying the plurality of data samples based on metadata (“meta”) attributes associated with each respective data sample of the plurality of data samples. Meta attributes of a data sample may include metadata and/or a number of annotations (when available) associated with the respective data sample. A hyper information frame, including at least a subset of the meta attributes for a corresponding data sample, may be created for each data sample in the dataset. As used herein, a hyper information frame is a machine learning data structure used to store (and/or represent) hyper information associated with a single data sample. Hyper information refers to one or more attributes, associated with a single data sample, used to control the data construction of a machine learning process. Subsequently, a condensed multi-dimensional subspace may be built to represent the created hyper information frames for the plurality of data samples (e.g., the subspace may be learned, for example, using an autoencoder, or by random projection), and the hyperinformation frames may be projected into the created subspace. The hyper information frames projected into the subspace may be grouped into one or more clusters (for example, using one or more clustering methods or algorithms). Each created cluster may be equivalent to a stratum in statistics. The created clusters may provide new mutually exclusive groups for the plurality of data samples that may be further sampled to yield one or more datasets (e.g., a training dataset, a validation dataset, and/or a test dataset for model training and/or evaluation). Sampling of the data samples within the created clusters to yield the one or more datasets (e.g., training, validation, and test) beneficially allows for the fair representation of each cluster in each of the one or more datasets. In this way, statistical discrepancy between the one or more datasets (e.g., between a training dataset and a validation dataset, for example) may be mitigated. As a result, model training and real-world performance is improved. This may relatedly save on compute resources otherwise dedicated to retraining models that fail to perform in real world tasks due to issues with the underlying training, validation, and/or test datasets. Because machine learning is extremely compute intensive, improving the training results in real world savings of power use, compute cycles, network activity, memory and storage, and other performance metrics.

Data stratification techniques described herein may be applied to myriad different types of datasets. For example, the data stratification techniques described herein may be applied to datasets comprising images with single annotations, images with multiple annotations, and/or images without annotations. The images may include photographs, videos, computed tomography (CT)/positron emission tomography (PET)/magnetic resonance imaging (MM) scans, and/or the like. Meta attributes for each of the images included in the dataset may be used for stratification.

For example, in certain aspects, the meta attributes include metadata associated with each image, such as exchangeable image file format (EXIF) data, digital imaging and communications in medicine (DICOM) data, Extensible Metadata Platform (XMP), Dublin Core Metadata (DCMI), International Press Telecommunications Council (IPTC) Information Interchange Model (IIM), Learning Object Metadata (LOM), and/or the like. Metadata components may be hierarchical, nested, linear, planar, and/or the like. In certain aspects, metadata components may be a mixture of one or more of the listed types (e.g., planar for objects in an image or video, but hierarchical for attributes and components of each object). Metadata included may be descriptive, structural, positional, situational, contextual, statistical, administrative, scientific (mathematical, biological, genetic, physical, chemical, engineering, social, economic, etc.,), medical, legal, financial, numerical, sentimental, perceptual, literal, Boolean, and/or the like (or a mixture of one or more of the listed types). Metadata may include information about how the data samples were acquired, curated, stored, processed, annotated, augmented, validated, split, merged, joined, and/or the like. In certain aspects, the meta attributes include feature(s), annotation(s) (including annotation(s)/captions produced for an image by an existing neural network), and/or the like associated with a respective image. In certain aspects, the meta attributes include meta augmentation attribute(s) generated for a respective data sample, such as a semantic summary of different objects identified in the image using, for example, machine vision and semantic segmentation techniques. Such meta attributes for each of the plurality of images in a dataset may be viewed in a concise space such that data stratification is handled beyond the complexity and necessity of structured annotations.

Although data stratification techniques described herein are described with respect to image data datasets and their corresponding annotations (when available), the techniques may be similarly applied to other classes of datasets and/or their accompanying annotations. For example, the aspects described herein are equally applicable to moving image (or video) data, audio data, sensor data, tabular data, natural language, synthetic language, and/or other structured and unstructured data types, as well as databases (e.g., relational or otherwise) and/or database entries. As another example, the techniques described herein may be applied to datasets having data samples with meta attributes that are capable of being converted and/or encoded in a numerical form (e.g., of any dimensionality and/or type (Boolean, integer, float, etc.), or a mixture of types).

The data stratification techniques described herein address the challenges of yielding fair (or unbiased) datasets of data samples, with or without annotations, in a dataset used for machine learning. For example, in certain aspects, the techniques described herein help to establish statistically similar (e.g., having similar underlying statistics) training, validation, and/or test datasets, which may be used to train and/or evaluate a model. Alleviating potential bias in training and/or validation datasets may help to reduce the risk of overfitting a machine learning model during training, while alleviating potential bias in test datasets may help to better evaluate a final version of the model by providing a dataset that more effectively probes the generalization performance of the model and its real-world performance. As such, with the improved data stratification yielded by the techniques described herein, results when using the test dataset for evaluating a trained model may be more reliable given the test dataset is expected to possess the same statistical properties as the training dataset. Such reliability may not be guaranteed where conventional techniques, such as random splitting or stratified random splitting (e.g., based on categorical labels) are used to stratify the dataset. Further, fair representations of data samples among one or more datasets may increase model training and inference efficiency by reducing, and in some cases eliminating, the need for ensemble models to address data bias among the generated datasets. Accordingly, data science, statistics, machine learning, and/or robotics algorithms that incorporate the data stratification techniques described herein may be more robust and less prone to overfitting, which results in better performance of the training stage as well as better performance in the task performance phase.

### Example Stratification in Non-Classified Heterogeneous Object Labels

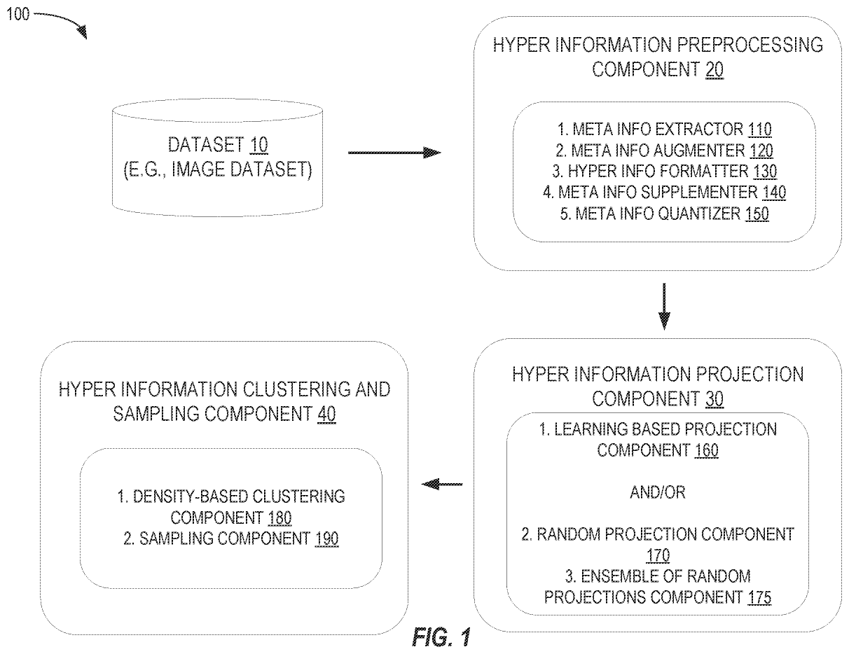

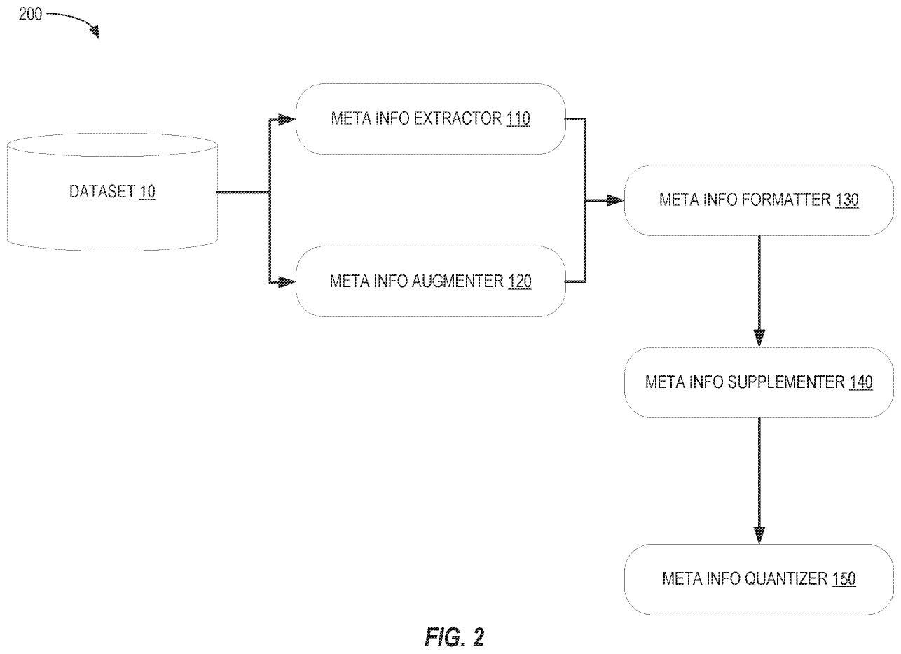

FIG. 1 illustrates an example system 100 in which a plurality of data samples in a dataset 10 are stratified for use in machine learning. As illustrated, system 100 includes a dataset 10, a hyper information preprocessing component 20, a hyper information projection component 30, and a hyper information clustering and sampling component 40. One or more of the illustrated components may be configured to extract attributes for a plurality of data samples in dataset 10 and use the extracted attributes to generate a plurality of hyper information frames (e.g., one hyper information frame per data sample), which may be clustered and further sampled to yield one or more datasets for model training and evaluation. The one or more datasets for model training and evaluation may include a training dataset, a validation dataset, and/or a test dataset. In certain aspects, the illustrated components are implemented in hardware (e.g., implemented in hardware, for example hardware of robots or autonomous vehicles). In certain aspects, the illustrated components are implemented in software, for example, as standalone software package(s) or as part of a machine learning framework. FIG. 2 illustrates example connectivity 200 between dataset 10 and components of hyper information preprocessing component 20, illustrated in FIG. 1, according to aspects of the present disclosure. Components of FIGS. 1 and 2 are concurrently described below.

Dataset 10, illustrated in FIG. 1, includes example data (e.g., data inputs and their corresponding target output(s) (or label(s))) used to train a machine learning model. In this example, dataset 10 includes a plurality of data samples which may be fed to machine learning algorithm(s) to train models how to make predictions and/or perform a desired task.

For example, dataset 10 may be an image dataset including a plurality of images (e.g., data samples) and their corresponding outputs (e.g., labels). The images may be used to teach a computer vision machine learning model to interpret and/or describe objects in each of the images. Data samples in dataset 10 may include data samples with and/or without annotation(s). Dataset 10 may be stored in one or more storage devices, which may be accessible by at least hyper information preprocessing component 20. According to aspects described herein, data samples of dataset 10 may be split into one or more datasets for use in machine learning. More specifically, data samples of dataset 10 may be stratified and sampled to yield one or more datasets (e.g., splits) for model training and/or evaluation, as well as for statistics and data analysis (e.g., significance, stationarity or homoskedasticity, etc.), single and/or multiple hypothesis testing, symbolic regression, and/or the like.

Hyper information preprocessing component 20 may be configured to process data samples from dataset 10, extract one or more meta attributes from each data sample in dataset 10, and manipulate and/or augment at least a subset of the one or more attributes associated with each data sample. In certain aspects, hyper information preprocessing component 20 includes meta information extractor 110, meta information augmenter 120, hyper information formatter 130, meta information supplementer 140, and/or meta information quantizer 150 configured to perform such operations.

In particular, meta information extractor 110 may be configured to process the data samples from dataset 10 and extract one or more meta attributes from each data sample in dataset 10. In certain aspects, meta attributes extracted for a data sample include a time associated with the respective data sample, a location associated with the respective data sample, an altitude or ground distance associated with the respective data sample, a device identity and setting associated with a device that created the respective data sample, a device status associated with a device that created the respective data sample, a device orientation (e.g., yaw, pitch roll, Euler angles, etc.) associated with a device that created the respective data sample, inertial measurement unit (IMU) and/or global positioning (GPS)/navigation system/ (or other similar system) readings (e.g., such as relative ground speed) associated with the respective data sample, and/or an ambient condition (e.g., ground, weather, atmospheric, spectral radiance, etc.) associated with the respective data sample. These are just some examples, and other meta attributes are possible. For example, the extracted time for a data sample may include a general description of the time of day (e.g., morning, afternoon, evening, etc.), a particular time (e.g., 5:00 pm, 6:30 am, etc.), and/or the like describing when the data sample was collected. As another example, the extracted location for a data sample may include a descriptor of a place or type of surroundings (e.g., a park, a museum, etc.), an exact location (e.g., city, state, latitude and longitude coordinates, combinations of the same, etc.), and/or the like describing where the data sample was collected. As another example, the extracted weather condition for a data sample may include a descriptor of the weather conditions (e.g., sunny, rainy, icy, temperature, etc.) when the data sample was collected, a season of the year (e.g., summer, fall, winter, spring) when the data sample was collected, and/or the like. As another example, the extracted device identity of a data sample may include serial number(s), firmware version(s), and/or internal status of a device that created the respective data sample (e.g., while an image/data was captured).

As an illustrative example, dataset 10 may include 500 images. Meta information extractor 110 may be configured to retrieve each of the 500 images included in dataset 10 and extract attributes associated with each of these images. Meta information extractor 110 may determine the first image was captured at 9:00 am in Austin, Tex. when it was raining outside. Meta information extractor 110 may similarly determine one or more attributes for the remaining 499 images.

In certain aspects, one or more annotations for a data sample (e.g., a label for each interested object in an image, such as a location label and/or size label) may be available. As such, meta attributes extracted for a data sample may include statistics and/or metadata associated with such annotations. For example, annotation statistics and/or metadata for a data sample may include a number of annotations associated with the respective data sample, a characteristic (e.g., a shape, a location, etc.), such as a contour and/or a bounding box around an identified feature in an image, of each annotation associated with the respective data sample, and/or an identity of an annotator associated with each annotation associated with the respective data sample. Said annotations may be generated and/or curated by single, or multiple, humans and/or algorithms (such as artificial neural networks).

Meta information extractor 110 may be further configured to provide (e.g., transmit, send, make available, etc.) such meta attributes extracted for each of the data sample in dataset 10 to, at least, hyper information formatter 130.

In addition to information provided to hyper information formatter 130 by meta information extractor 110, meta information augmenter 120 may also be configured to provide information to hyper information formatter 130. In particular, meta information augmenter 120 may be configured to generate one or more meta augmentation attributes for each respective data sample of dataset 10. As used herein, meta augmentation attributes refer to generated data, representing the characteristics and/or features of a data sample, used to supplement a given corpus of attributes extracted for a respective data sample. These meta augmentation attributes may be provided to hyper information formatter 130 to supplement information for each data sample provided to hyper information formatter 130 by meta information extractor 110.

In certain aspects, a meta augmentation attribute generated by meta information augmenter 120 for a data sample includes a semantic summary (e.g., generated using machine vision) of the respective data sample (e.g., “an image taken indoors in a poor lighting condition”). In certain aspects, a meta augmentation attribute generated by meta information augmenter 120 for a data sample includes a textual description of the respective data sample. The textual description may describe the content and/or context of the data sample (e.g., the content captured in an image, where the data sample is an image). In certain aspects, a model that understands the context and/or content of the data sample, generates the textual description. In certain aspects, meta information augmenter 120 converts the textual description, generated for a particular data sample, to a fixed character length prior to providing the textual description to hyper information formatter 130.

In certain aspects, meta augmentation attributes include contextual information not included, and/or not obvious, in the original data set. This information may be generated by computational and/or rule-based models.

As mentioned above, in this example, hyper information formatter 130 obtains (e.g., receives) (1) extracted meta attribute(s) for data samples of dataset 10 from meta information extractor 110 and (2) meta augmentation attribute(s) for data samples of dataset 10 from meta information augmenter 120. With this information, hyper information formatter 130 may generate a plurality of hyper information frames, wherein each respective hyper information frame of the plurality of hyper information frames is associated with a respective data sample in dataset 10. For example, where dataset 10 includes 500 images, hyper information formatter 130 may be configured to generate 500 hyper information frames, where each frame corresponds to a single image. Each hyper information frame generated by hyper information formatter 130 may include (1) the data sample associated with the hyper information frame and (2) at least a subset of the one or more meta attributes extracted from the respective data sample.

For example, in certain aspects, generating a hyper information frame for each respective data sample in dataset 10 involves identifying a subset of meta attributes among the plurality of data samples having a highest availability within the dataset 10. Meta attributes having a highest availability may be meta attributes present for a majority of the data samples subject to, for example, some availability threshold (e.g., available within 80% of the samples). As an illustrative example, for 500 image data samples, a time attribute may have been extracted for 450 of the 500 data samples, a location attribute may have been extracted for 490 of the 500 data samples, and a weather attribute may have been extracted for 50 of the 500 data samples. Accordingly, meta attributes having a highest availability among attributes collected for data samples in dataset 10 may include time and location attributes, but not weather attributes. In certain aspects, the subset of the one or more meta attributes, included in each of the hyper information frames, are arranged in an alphabetical order, a numerical order, a chronological order, or some ordering, in each of the hyper information frames.

In certain aspects, the subset of the one or more meta attributes included for each data sample in each respective hyper information frame is based on user input. In particular, hyper information formatter 130 may be configured to provide a presentation of extracted attributes for the data samples of dataset 10 (or only attributes having a highest availability among data samples in dataset 10) to a user. The user may then select which of these presented attributes are to be included (and which presented attributes are not to be included) in a respective hyper information frame generated for each data sample.

In certain aspects, an algorithm is used to determine the subset of the one or more meta attributes which are to be included for each data sample in each respective hyper information frame. In other words, determining the subset of the one or more meta attributes is automated (e.g., without user intervention).

In certain aspects, a hyper information frame generated for a data sample may further include one or more meta augmentation attributes generated for the data sample and provided to hyper information formatter 130, for example, by meta information augmenter 120.

In certain aspects, meta attributes extracted for a data sample may miss one or more meta attributes to be included in a hyper information frame generated for the data sample. For example, meta attributes extracted for a data sample may include time and location information associated with the data sample, but not weather information, even though a weather information meta attribute is meant to be included in hyper information frames generated for the data samples. Accordingly, in certain aspects, generating a hyper information frame for the respective data sample involves hyper information formatter 130 supplementing the hyper information frame with a null value for at least one meta attribute of the one or more meta attributes (e.g., the missing attribute). In other words, hyper information formatter 130 may generate a null value for the missing attribute and include this null value in the hyper information frame generated for the respective data sample. The null value may be considered as a placeholder for the missing attribute, such as described further below. Generally, the augmentation ensures that downstream processing can be performed without issue.

Hyper information formatter 130 may be further configured to provide (e.g., transmit, send, make available, etc.) the generated hyper information frames for the data samples of dataset 10 to meta information supplementer 140. Meta information supplementer 140 may be configured to augment one or more hyper information frames, obtained from hyper information formatter 130, with a substitute meta attribute value for at least one meta attribute of the one or more meta attributes. For example, as described above, in some cases, null values may be used as placeholders for one or more attributes in a hyper information frame generated for a data sample. Meta information supplementer 140 may be configured to located this null value and replace the null value with a substitute (or augmented) meta attribute value. In certain aspects, the substitute meta attribute value is a randomly selected value (e.g., randomly selected by meta information supplementer 140). In certain aspects, the substitute meta attribute value is a statistical value, such as an average or median value (or other statistic) corresponding to the attribute for which the value is generated for and based on the available meta attribute values for other data samples in the dataset.

Meta information supplementer 140 may be further configured to provide the plurality of hyper information frames for the data samples of dataset 10 to meta information quantizer 150. Meta information quantizer 150 may be configured to convert any non-numeric attribute value in each obtained hyper information frame into a numeric attribute value. In certain aspects, converting a non-numeric attribute value to a numeric attribute value includes normalizing the numeric value across the plurality of hyper information frames. In certain aspects, converting a non-numeric attribute value to a numeric attribute value includes mapping the non-numeric attribute value to the numeric attribute value using a codebook, look-up table, or another data conversion structure mapping input values to output values.

In certain aspects, hierarchical, or nested, aspects of hyper information may be represented by respectively more or less significant bits (components) of a numeric representation, reflecting how far in the hierarchy the differences occur. For example, consider nested categories such as “books>science>physics>heat”, “books>science>chemistry>solvents”, and “art supplies>solvents”. The difference between books and art supplies occurs at the base of the hierarchy, so this hyper information may be encoded by the more significant bit(s) of the numerical encoding. Conversely, the difference between chemistry books and physics books occurs two levels further within the hierarchy; thus, this hyper information may be encoded by the less significant bit(s) of the numerical encoding.

After the processing described above, the plurality of hyper information frames may be provided to hyper information projection component 30.

Hyper information projection component 30 may be configured to obtain the hyper information frames from hyper information preprocessing component 20 and generate reduced dimensionality hyper information frames. For example, hyper information projection component 30 may apply one or more dimensionality reduction approaches to create compact, data and processing efficient representations of the hyper information frames for subsequent processing. In other words, hyper information projection component 30 projects each hyper information frame to a reduced dimensional latent space. In certain aspects, hyper information projection component 30 includes learning-based projection component 160 to perform such operations. In certain aspects, hyper information projection component 30 includes random projection component 170 and ensemble of random projections component 175 to perform such operations.

In certain aspects, a learning-based projection component 160 may be configured to project each of the hyper information frames to a reduced dimensionality latent space in a principled manner, for example using an autoencoder or a dimensionality reduction algorithm. An autoencoder is generally a machine learning model (e.g., artificial neural network) that learns how to efficiently compress and encode data into a latent space and how to reconstruct (e.g., decode) the reduced encoded representation to a representation that is as close to the original input as possible. In certain aspects, the dimensionality reduction algorithm is a principal component analysis (PCA), linear discriminant analysis (LDA), or similar algorithm. In certain aspects, the dimensionality reduction algorithm is an independent component analysis (ICA) algorithm. In certain aspects, the output of the dimensionality reduction algorithm (for example, the spectrum of eigenvalues and/or the statistics of the projection values) is used to quantify the relative importance of the hyper information features, and/or their combinations.

In certain aspects, only a particular number of projections of the hyper information frames, which is less than all projections of the hyper information frames, may be retained. In particular, retaining only a particular number of projections of the hyper information frames helps to reduce the risk of having artifacts (e.g., caused by noisy data samples) in the learned projection basis. In other words, “Occam's razor” (also known as the “principle of parsimony” or the “law of parsminoy”) may be used to remove overly-learned projections. Further, the retained projections may be the “most important” and/or “most informative” projections created. In certain aspects, an amount of projections retained may be based on an amount of data that is available. In certain aspects, an amount of projections retained is determined based on the amount of available data samples versus the relative importance of the projections, for example, using an information-theoretical criterion. In certain aspects, an amount of projections retained is determined by applying an “elbow method” heuristic conventionally used in unsupervised machine learning.

In certain other aspects, random projection component 170 may be configured to project each hyper information frame to a reduced dimensionality latent space using a random projection. In other words, random projection component 170 may be configured to project each of the hyper information frames using a random basis algorithm. In certain aspects, an ensemble of random projections component 175 is configured to mitigate the randomness which helps to produce a more robust clustering outcome.

After processing by hyper information projection component 30, the plurality of hyper information frames, projected in the reduced dimensional latent space, may be provided to hyper information clustering and sampling component 40 for further processing.

Hyper information clustering and sampling component 40 may be configured to process the reduced dimensionality hyper information frames from hyper information projection component 30 in order to generate the stratified data subsets. For example, in the depicted example, hyper information clustering and sampling component 40 is configured to cluster the reduced dimensionality hyper information frames into a plurality of clusters, and stratify the data samples by sampling from the plurality of clusters.

In certain aspects, hyper information clustering and sampling component 40 stratifies the data samples by sampling from the plurality of clusters to generate a set of training data samples, a set of validation data samples, and/or a set of test data samples. The set of training data samples, the set of validation data samples, and/or the set of test data samples may be used to train and/or evaluate a machine learning model. In certain aspects, hyper information clustering and sampling component 40 includes density based clustering component 180 and sampling component 190 that are configured to perform such operations.

In certain aspects, the sampling is performed in a density-based manner. For example, in certain aspects, hyper information clustering and sampling component 40 clusters the reduced dimensionality hyper information frames into a plurality of clusters by applying a density-based spatial clustering of applications with noise (DBSCAN) clustering algorithm to the reduced dimensionality hyper information frames. A DBSCAN clustering algorithm is a density-based clustering algorithm that works on the assumption that clusters are dense regions in space separated by regions of lower density. Accordingly, the DBSCAN clustering algorithm may group “densely grouped” data points into a single cluster. In certain other aspects, other clustering approaches, such as k-means and its variants and/or spectral clustering, may be used to perform the clustering. Regardless of the clustering method and/or algorithm use, the clustering may be performed to help ensure that data samples of different clusters have equal chances to be sampled (e.g., to result in fair partitions of dataset 10). In certain aspects, data samples belonging to different cluster are stratified by a cluster index to aid in adequate and statically fair splitting of the data samples.

In certain aspects, data samples within each cluster may be further randomly sampled to form sub-groups (or subsets) within each of the formed clusters. For example, hyper information clustering and sampling component 40 may be configured to further cluster the reduced dimensionality hyper information frames belonging to each of the plurality of clusters into sub-groups. In such cases, stratifying the data samples may involve sampling from the plurality of sub-groups, as opposed to the plurality of clusters.

In certain aspects, weights may be assigned to each of the data samples in dataset 10. For example, weights may be assigned according to a respective (inverse) frequency of the corresponding plurality of clusters.

### Example Method for Stratifying Data Samples for Use in Machine Learning

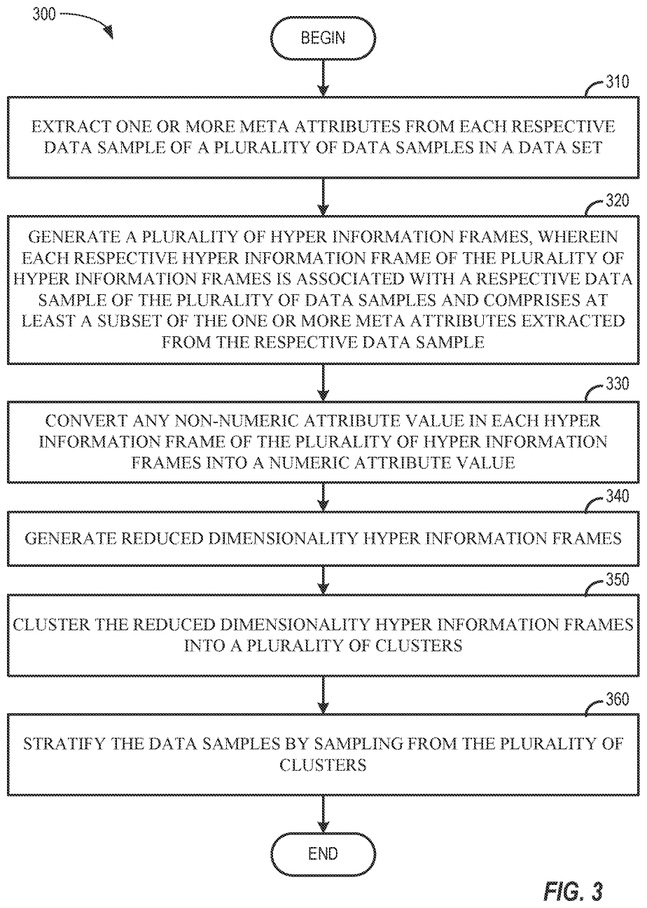

FIG. 3 illustrates example operations that may be performed by a computing system to stratify a plurality of data samples, with or without annotations, in a dataset for use in machine learning.

As illustrated, operations 300 begin at block 310, with extracting one or more meta attributes from each respective data sample of a plurality of data samples in a dataset.

At block 320, operations 300 proceed with generating a plurality of hyper information frames. In certain aspects, each respective hyper information frame of the plurality of hyper information frames is associated with a respective data sample of the plurality of data samples. In certain aspects, each respective hyper information frame of the plurality of hyper information frames includes at least a subset of the one or more meta attributes extracted from the respective data sample. In certain aspects, the subset of the one or more attributes are arranged in an alphabetical order, a numerical order, or a chronological order in each hyper information frame of the plurality of hyper information frames.

In certain aspects, generating the hyper information frame for each respective data sample of the plurality of data samples includes identifying the subset of the one or more meta attributes in the plurality of data samples having the highest availability within the dataset.

In certain aspects, generating the hyper information frame for at least one respective data sample of the plurality of data samples includes supplementing the hyper information frame with a substitute meta attribute value for at least one meta attribute of the one or more meta attributes. In certain aspects, the substitute meta attribute value for the at least one meta attribute comprises a randomly selected value or a median value among values for the at least one meta attribute for the plurality of data samples.

At block 330, operations 300 proceed with converting any non-numeric attribute value in each hyper information frame of the plurality of hyper information frames into a numeric attribute value.

In certain aspects, converting any non-numeric attribute value in the hyper information frame for each respective data sample of the plurality of data samples into a numeric attribute value includes normalizing the numeric value across the plurality of hyper information frames associated with the plurality of data samples.

In certain aspects, converting any non-numeric attribute value in the hyper information frame for each respective data sample of the plurality of data samples into a numeric attribute value includes mapping the non-numeric attribute value to the numeric attribute value using a codebook.

In certain aspects, generating the hyper information frame for each respective data sample of the plurality of data samples includes presenting, to a user, one or more meta attributes extracted for each respective data sample of the plurality of data samples and receiving input from the user to include the subset of the one or more attributes in each of the plurality of hyper information frames generated for each data sample of the plurality of data samples.

At block 340, operations 300 proceed with generating reduced dimensionality hyper information frames.

In certain aspects, generating the reduced dimensionality hyper information frames includes projecting each hyper information frame of the plurality of hyper information frames to a reduced dimensional latent space using at least one of: an autoencoder, a dimensionality reduction algorithm, or a random projection.

At block 350, operations 300 proceed with clustering the reduced dimensionality hyper information frames into a plurality of clusters.

In certain aspects, clustering the reduced dimensionality hyper information frames into a plurality of clusters includes applying a spectral clustering algorithm or a density-based clustering algorithm to the reduced dimensionality hyper information frames.

At block 360, operations 300 proceed with stratifying the data samples by sampling from the plurality of clusters.

In certain aspects, stratifying the data samples by sampling from the plurality of clusters includes generating at least: a set of training data samples, a set of validation data samples, and a set of test data samples.

In certain aspects, operations 300 further include determining the subset of the one or more attributes to include in each respective hyper information frame of the plurality of hyper information frames via an algorithm.

In certain aspects, operations 300 further include generating one or more meta augmentation attributes for each respective data sample of the plurality of data samples. In certain aspects, the hyper information frame for each respective data sample of the plurality of data samples further includes the one or more meta augmentation attributes. In certain aspects, at least one meta augmentation attribute includes a textual description of the respective data sample. In certain aspects, operations 300 further include converting the textual description to a fixed character length.

In certain aspects, the data sample includes image data. In certain aspects, at least one of the one or more meta attributes for the data sample (e.g., image data) includes a time associated with the respective data sample, a location associated with the respective data sample, a device setting associated with a device that created the respective data sample, a device status associated with the device that created the respective data sample, or a weather condition associated with the respective data sample. In certain aspects, at least one of the one or more meta attributes for the data sample (e.g., image data) includes a number of annotations associated with the respective data sample, a characteristic of each annotation associated with the respective data sample, or an identity of annotator associated with each annotation associated with the respective data sample.

In certain aspects, operations 300 further include clustering the reduced dimensionality hyper information frames belonging to each of the plurality of clusters into a plurality of sub-groups. In certain aspects, stratifying the data samples comprises sampling from the plurality of sub-groups.

Note that FIG. 3 is just one example of a method consistent with aspects described herein, and other methods having additional, alternative, or fewer steps are possible consistent with this disclosure.

### Example Processing System for Stratifying Data Samples for Use in Machine Learning

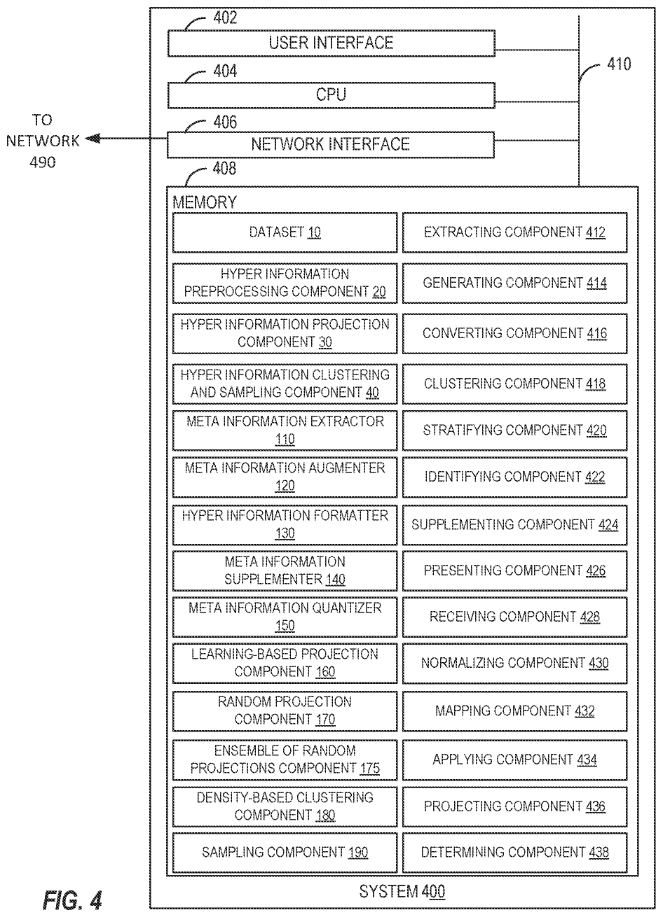

FIG. 4 illustrates an example processing system 400 configured to perform the methods described herein, including, for example, operations 300 of FIG. 3. In some embodiments, system 400 may act as a computing system on which a plurality of data samples in a dataset are stratified for use in machine learning.

As shown, system 400 includes a user interface 402, a central processing unit (CPU) 404, a network interface 406 through which system 400 is connected to network 490 (which may be a local network, an intranet, the internet, or any other group of computing devices communicatively connected to each other), and a memory 408, connected via an interconnect 410.

User interface 402 is configured to provide a point at which users may be able to interact with system 400. User interface 402 may allow users to interact with system 400 in a natural and intuitive way. In certain aspects, user interface 402 is a graphical user interface which allows users to interact with system 400 through interactive visual components.

CPU 404 may retrieve and execute programming instructions stored in the memory 408. Similarly, the CPU 404 may retrieve and store application data residing in the memory 408. The interconnect 410 transmits programming instructions and application data, among the CPU 404, network interface 406, and memory 408.

CPU 404 is included to be representative of a single CPU, multiple CPUs, a single CPU having multiple processing cores, and the like.

Memory 408 is representative of a volatile memory, such as a random access memory, or a nonvolatile memory, such as nonvolatile random access memory, phase change random access memory, or the like. As shown, memory 408 includes dataset 10, a hyper information preprocessing component 20, a hyper information projection component 30, a hyper information clustering and sampling component 40, a meta information extractor 110, a meta information augmenter 120, a hyper information formatter 130, a meta information supplementer 140, a meta information quantizer 150, a learning-based projection component 160, a random projection component 170, an ensemble of random projections component 175, a density-based clustering component 180, and a sampling component 190. Further, as shown, memory 408 includes an extracting component 412, a generating component 414, a converting component 416, a clustering component 418, a stratifying component 420, an identifying component 422, an supplementing component 424, a presenting component 426, a receiving component 428, a normalizing component 430, a mapping component 432, an applying component 434, a projecting component, and determining component 438.

As described herein, dataset 10 includes a plurality of data samples which may be fed to machine learning algorithm(s) to train models how to make predictions and/or perform a desired task Hyper information preprocessing component 20 generally is configured to retrieve data samples from a dataset, extract one or more meta attributes from each data sample in the dataset, and manipulate and/or augment at least a subset of the one or more attributes associated with each data sample, and generate a hyper information frame for each data sample. Hyper information projection component 30 generally is configured to obtain hyper information frames from hyper information preprocessing component 20 and generate reduced dimensionality hyper information frames. Hyper information clustering and sampling component 40 generally is configured to obtain the reduced dimensionality hyper information frames from hyper information projection component 30, cluster the reduced dimensionality hyper information frames into a plurality of clusters, and stratify data samples of the dataset by sampling from the plurality of clusters.

In certain aspects, meta information extractor 110 generally is configured to process data samples from dataset 10 and extract one or more meta attributes from each data sample in dataset 10.

In certain aspects, meta information augmenter 120 generally is configured to generate one or more meta augmentation attributes for each respective data sample of dataset 10.

In certain aspects, hyper information formatter 130 generally is configured to generate a plurality of hyper information frames.

In certain aspects, meta information supplementer 140 generally is configured to augment one or more generated hyper information frames with a substitute meta attribute value for at least one meta attribute of one or more meta attributes included in the hyper information frames.

In certain aspects, meta information quantizer 150 generally is configured to convert any non-numeric attribute value in each obtained hyper information frame into a numeric attribute value.

In certain aspects, learning-based projection component 160 generally is configured to project hyper information frames to a reduced dimensionality latent space in a principled manner, for example using an autoencoder or a dimensionality reduction algorithm.

In certain aspects, random projection component 170 generally is configured to project hyper information frames to a reduced dimensionality latent space using a random projection.

In certain aspects, ensemble of random projections component 175 generally is configured to mitigate randomness.

In certain aspects, density-based clustering component 180 generally is configured to cluster reduced dimensionality hyper information frames into a plurality of clusters.

In certain aspects, sampling component 190 generally is configured to process the reduced dimensionality hyper information frames in order to generate stratified data subsets.

In certain aspects, extracting component 412 generally is configured to extract one or more meta attributes from each respective data sample of a plurality of data samples in a dataset.

In certain aspects, generating component 414 generally is configured to generate a plurality of hyper information frames. In certain aspects, generating component 414 generally is configured to generate one or more meta augmentation attributes for each respective data sample of a plurality of data samples. In certain aspects, generating component 414 generally is configured to generate at least: a set of training data samples, a set of validation data samples, and a set of test data samples.

In certain aspects, converting component 416 generally is configured to convert any non-numeric attribute value in each hyper information frame of a plurality of hyper information frames into a numeric attribute value. In certain aspects, converting component 416 generally is configured to convert a textual description to a fixed character length.

In certain aspects, clustering component 418 generally is configured to cluster reduced dimensionality hyper information frames into a plurality of clusters. In certain aspects, clustering component 418 generally is configured to cluster reduced dimensionality hyper information frames belonging to each of a plurality of clusters into a plurality of sub-groups.

In certain aspects, stratifying component 420 generally is configured to stratify data samples by sampling from a plurality of clusters.

In certain aspects, identifying component 422 generally is configured to identify a subset of one or more meta attributes in a plurality of data samples having a highest availability within a dataset.

In certain aspects, supplementing component 424 generally is configured to supplement a hyper information frame with a substitute meta attribute value for at least one meta attribute of the one or more meta attributes.

In certain aspects, presenting component 426 generally is configured to present, to a user, one or more meta attributes extracted for each respective data sample of a plurality of data samples.

In certain aspects, receiving component 428 generally is configured to receive input from a user to include a subset of the one or more attributes in each of a plurality of hyper information frames generated for each data sample of a plurality of data samples.

In certain aspects, normalizing component 430 generally is configured to normalize a numeric value across a plurality of hyper information frames associated with a plurality of data samples.

In certain aspects, mapping component 432 generally is configured to map a non-numeric attribute value to a numeric attribute value using a codebook.

In certain aspects, applying component 434 generally is configured to apply a DBSCAN clustering algorithm to reduced dimensionality hyper information frames.

In certain aspects, projecting component 436 generally is configured to project each hyper information frame of a plurality of hyper information frames to a reduced dimensional latent space using at least one of: an autoencoder, a dimensionality reduction algorithm, or a random projection.

In certain aspects, determining component 438 generally is configured to determine the subset of the one or more attributes to include in each respective hyper information frame of the plurality of hyper information frames via an algorithm.

Note that FIG. 4 is just one example of a processing consistent with aspects described herein, and other processing systems having additional, alternative, or fewer components are possible consistent with this disclosure.

### EXAMPLE CLAUSES

Implementation details of various aspects of the present disclosure are described in the following numbered clauses.

Clause 1: A method of stratifying data samples for use in at least one of machine learning and data analytics, comprising: extracting one or more meta attributes from each respective data sample of a plurality of data samples in a dataset; generating a plurality of hyper information frames, wherein each respective hyper information frame of the plurality of hyper information frames is associated with a respective data sample of the plurality of data samples and comprises at least a subset of the one or more meta attributes extracted from the respective data sample; converting any non-numeric attribute value in each hyper information frame of the plurality of hyper information frames into a numeric attribute value; generating reduced dimensionality hyper information frames; clustering the reduced dimensionality hyper information frames into a plurality of clusters; and stratifying the data samples by sampling from the plurality of clusters.

Clause 2: The method of Clause 1, wherein generating the hyper information frame for each respective data sample of the plurality of data samples comprises identifying the subset of the one or more meta attributes in the plurality of data samples having the highest availability within the dataset.

Clause 3: The method of any one of Clauses 1-2, wherein generating the hyper information frame for at least one respective data sample of the plurality of data samples comprises supplementing the hyper information frame with a substitute meta attribute value for at least one meta attribute of the one or more meta attributes.

Clause 4: The method of Clause 3, wherein the substitute meta attribute value for the at least one meta attribute comprises a randomly selected value or a median value among values for the at least one meta attribute for the plurality of data samples.

Clause 5: The method of any one of Clauses 1-4, wherein generating the hyper information frame for each respective data sample of the plurality of data samples comprises: presenting, to a user, the one or more meta attributes extracted for each respective data sample of the plurality of data samples; and receiving input from the user to include the subset of the one or more attributes in each of the plurality of hyper information frames generated for each data sample of the plurality of data samples.

Clause 6: The method of any one of Clauses 1-5, further comprising determining the subset of the one or more attributes to include in each respective hyper information frame of the plurality of hyper information frames via an algorithm.

Clause 7: The method of any one of Clauses 1-6, wherein the subset of the one or more attributes are arranged in an alphabetical order, a numerical order, or a chronological order in each hyper information frame of the plurality of hyper information frames.

Clause 8: The method of any one of Clauses 1-7, further comprising: generating one or more meta augmentation attributes for each respective data sample of the plurality of data samples, wherein the hyper information frame for each respective data sample of the plurality of data samples further comprises the one or more meta augmentation attributes.

Clause 9: The method of Clause 8, wherein at least one meta augmentation attribute comprises a textual description of the respective data sample.

Clause 10: The method of Clause 9, further comprising converting the textual description to a fixed character length.

Clause 11: The method of any one of Clauses 1-10, wherein the data sample comprises image data.

Clause 12: The method of Clause 11, wherein at least one of the one or more meta attributes comprises: a time associated with the respective data sample; a location associated with the respective data sample; a device setting associated with a device that created the respective data sample; a device status associated with the device that created the respective data sample; or a weather condition associated with the respective data sample.

Clause 13: The method of any one of Clauses 11-12, wherein at least one of the one or more meta attributes comprises: a number of annotations associated with the respective data sample; a characteristic of each annotation associated with the respective data sample; or an identity of annotator associated with each annotation associated with the respective data sample.

Clause 14: The method of any one of Clauses 1-13, wherein converting any non-numeric attribute value in the hyper information frame for each respective data sample of the plurality of data samples into a numeric attribute value comprises normalizing the numeric value across the plurality of hyper information frames associated with the plurality of data samples.

Clause 15: The method of any one of Clauses 1-14, wherein converting any non-numeric attribute value in the hyper information frame for each respective data sample of the plurality of data samples into a numeric attribute value comprises mapping the non-numeric attribute value to the numeric attribute value using a codebook.

Clause 16: The method of any one of Clauses 1-15, wherein generating the reduced dimensionality hyper information frames comprises projecting each hyper information frame of the plurality of hyper information frames to a reduced dimensional latent space using at least one of: an autoencoder; a dimensionality reduction algorithm; or a random projection.

Clause 17: The method of any one of Clauses 1-16, wherein clustering the reduced dimensionality hyper information frames into a plurality of clusters comprises applying a spectral clustering algorithm or a density-based clustering algorithm to the reduced dimensionality hyper information frames.

Clause 18: The method of any one of Clauses 1-17, wherein stratifying the data samples by sampling from the plurality of clusters comprises generating at least: a set of training data samples; a set of validation data samples; and a set of test data samples.

Clause 19: A processing system, comprising: a memory having executable instructions stored thereon; and a processor configured to execute the executable instructions to cause the processing system to perform the operations of any one of Clauses 1 through 18.

Clause 20: A processing system, comprising: means for performing the operations of any one of Clauses 1 through 18.

Clause 21: A computer-readable medium having executable instructions stored thereon which, when executed by a processor, causes the processor to perform the operations of any one of clauses 1 through 18.

### ADDITIONAL CONSIDERATIONS

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. §112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of stratifying data samples for use in at least one of machine learning and data analytics, comprising:
extracting one or more meta attributes from each respective data sample of a plurality of data samples in a dataset;
generating a plurality of hyper information frames, wherein each respective hyper information frame of the plurality of hyper information frames is associated with a respective data sample of the plurality of data samples and comprises at least a subset of the one or more meta attributes extracted from the respective data sample;
converting any non-numeric attribute value in each hyper information frame of the plurality of hyper information frames into a numeric attribute value;
generating reduced dimensionality hyper information frames;
clustering the reduced dimensionality hyper information frames into a plurality of clusters; and
stratifying the data samples by sampling from the plurality of clusters.

2. The method of claim 1, wherein generating the hyper information frame for each respective data sample of the plurality of data samples comprises identifying the subset of the one or more meta attributes in the plurality of data samples having a highest availability within the dataset.

3. The method of claim 1, wherein generating the hyper information frame for at least one respective data sample of the plurality of data samples comprises supplementing the hyper information frame with a substitute meta attribute value for at least one meta attribute of the one or more meta attributes.

4. The method of claim 3, wherein the substitute meta attribute value for the at least one meta attribute comprises a randomly selected value or a median value among values for the at least one meta attribute for the plurality of data samples.

5. The method of claim 1, wherein generating the hyper information frame for each respective data sample of the plurality of data samples comprises:
presenting, to a user, the one or more meta attributes extracted for each respective data sample of the plurality of data samples; and
receiving input from the user to include the subset of the one or more meta attributes in each of the plurality of hyper information frames generated for each data sample of the plurality of data samples.

6. The method of claim 1, further comprising determining the subset of the one or more meta attributes to include in each respective hyper information frame of the plurality of hyper information frames via an algorithm.

7. The method of claim 1, wherein the subset of the one or more meta attributes are arranged in an alphabetical order, a numerical order, or a chronological order in each hyper information frame of the plurality of hyper information frames.

8. The method of claim 1, further comprising:
generating one or more meta augmentation attributes for each respective data sample of the plurality of data samples,
wherein the hyper information frame for each respective data sample of the plurality of data samples further comprises the one or more meta augmentation attributes.

9. The method of claim 8, wherein at least one meta augmentation attribute comprises a textual description of the respective data sample.

10. The method of claim 9, further comprising converting the textual description to a fixed character length.

11. The method of claim 1, wherein the data sample comprises image data.

12. The method of claim 11, wherein at least one of the one or more meta attributes comprises:
a time associated with the respective data sample;
a location associated with the respective data sample;
a device setting associated with a device that created the respective data sample;
a device status associated with the device that created the respective data sample; or
a weather condition associated with the respective data sample.

13. The method of claim 11, wherein at least one of the one or more meta attributes comprises:
a number of annotations associated with the respective data sample;
a characteristic of each annotation associated with the respective data sample; or
an identity of annotator associated with each annotation associated with the respective data sample.

14. The method of claim 1, wherein converting any non-numeric attribute value in the hyper information frame for each respective data sample of the plurality of data samples into a numeric attribute value comprises normalizing the numeric attribute value across the plurality of hyper information frames associated with the plurality of data samples.

15. The method of claim 1, wherein converting any non-numeric attribute value in the hyper information frame for each respective data sample of the plurality of data samples into a numeric attribute value comprises mapping the non-numeric attribute value to the numeric attribute value using a codebook.

16. The method of claim 1, wherein generating the reduced dimensionality hyper information frames comprises projecting each hyper information frame of the plurality of hyper information frames to a reduced dimensional latent space using at least one of:
an autoencoder;
a dimensionality reduction algorithm; or
a random projection.

17. The method of claim 1, wherein clustering the reduced dimensionality hyper information frames into the plurality of clusters comprises applying a spectral clustering algorithm or a density-based clustering algorithm to the reduced dimensionality hyper information frames.

18. The method of claim 1, wherein stratifying the data samples by sampling from the plurality of clusters comprises generating at least:
a set of training data samples;
a set of validation data samples; and
a set of test data samples.

19. An apparatus comprising:
one or more processors; and
at least one memory, the one or more processors and the at least one memory configured to:
extract one or more meta attributes from each respective data sample of a plurality of data samples in a dataset;
generate a plurality of hyper information frames, wherein each respective hyper information frame of the plurality of hyper information frames is associated with a respective data sample of the plurality of data samples and comprises the data sample and at least a subset of the one or more meta attributes extracted from the respective data sample;
convert any non-numeric attribute value in each hyper information frame of the plurality of hyper information frames into a numeric attribute value;
generate reduced dimensionality hyper information frames;
cluster the reduced dimensionality hyper information frames into a plurality of clusters; and
stratify the data samples by sampling from the plurality of clusters.

20. A non-transitory computer-readable medium comprising instructions that, when executed by one or more processors of a computing system, cause the computing system to perform operations for stratifying data samples for use in at least one of machine learning and data analytics, the operations comprising:
extracting one or more meta attributes from each respective data sample of a plurality of data samples in a dataset;
generating a plurality of hyper information frames, wherein each respective hyper information frame of the plurality of hyper information frames is associated with a respective data sample of the plurality of data samples and comprises the data sample and at least a subset of the one or more meta attributes extracted from the respective data sample;
converting any non-numeric attribute value in each hyper information frame of the plurality of hyper information frames into a numeric attribute value;
generating reduced dimensionality hyper information frames;
clustering the reduced dimensionality hyper information frames into a plurality of clusters; and
stratifying the data samples by sampling from the plurality of clusters.
